(19) United States
(12) Patent Application Publication
(10) Pub. No.: US 2020/0087172 A1
(43) Pub. Date: Mar. 19, 2020

(54) LIQUID TREATMENT APPARATUS

(71) Applicant: ASTA Solutions Limited, Monmouthshire (GB)

(72) Inventor: Oleksander Pivivarov, Dnipropetrovsk (UA)

(21) Appl. No.: 16/422,371

(22) Filed: May 24, 2019

Related U.S. Application Data
(63) Continuation of application No. 14/759,849, filed on Jul. 8, 2015, now abandoned.

(51) Int. Cl. C02F 1/463; C02F 1/48; C02F 1/467; C02F 1/461

(52) U.S. Cl. CPC C02F 1/463; C02F 1/484; C02F 1/001; C02F 1/46104; C02F 1/4672

(57) ABSTRACT

A liquid treatment apparatus comprises a liquid flow channel (26) configured to receive and channel liquid; and plasma generation means. The plasma generation means is arranged and configured to generate a plasma field in the gas phase above the liquid flow channel (26) to contact the surface of the liquid flowing therethrough to act on the liquid to cause impurities dissolved therein to form solid insoluble material which may be removed from the liquid by conventional filtration methods. The plasma generation means comprises at least one electrode (40) defining an anode, and at least one cathode (24) element spaced from the at least one electrode (40). The at least one electrode is located such that when liquid flows through the flow channel (26) the at least one electrode (40) is spaced above the surface of the liquid in the gaseous phase and the at least one cathode (24) is located within the flow channel (26) and arranged such that when liquid flows through the flow channel (26) it is at least partially submerged beneath the surface of the liquid, such that the plasma field is generated in the gas phase and extends to and contacts the surface of the liquid.

The present invention relates to a liquid treatment apparatus and in particular an apparatus for the treatment and purification of water.

The prevention of environmental pollution through the discharge of contaminated water, and the processing of contaminated water for the purification of drinking water, requires technologies for removing contaminants from a water source. Such contaminants may include heavy metals or dissolved toxic substances. Worldwide industrial expansion has led to a significant increase in the levels of industrially generated contaminated water. The treatment of such water for supplying clean drinking water presents particular problems, due to the level to which the water must be cleansed before it is fit for human consumption.

Large scale industrial processes are known for the treatment and purification of water. However, there is an increasing desire for such processes to be made more efficient. In addition, there is a need for smaller scale, efficient means of water treatment for application in third world countries or for use by the military, in areas where access to larger scale industrial processing facilities is not possible.

It is therefore desirable to provide an improved liquid treatment apparatus which addresses the above described problems and/or which offers improvements generally.

According to the present invention there is provided a liquid treatment apparatus as described in the accompanying claims.

In an embodiment of the invention there is provided a liquid treatment apparatus comprising a liquid flow channel configured to receive and channel liquid; and plasma generation means. The plasma generation means is arranged and configured to generate a plasma field in the gas phase above the liquid flow channel to contact the surface of the liquid flowing therethrough. The application of a plasma field generated in the gas phase to the surface of a liquid has been surprisingly and advantageously found to act on the liquid to cause impurities dissolved therein to form solid insoluble material which may be removed from the liquid by conventional filtration methods. In addition, it has been found that the action of the plasma field acts to alter the structure of the liquid, and in particular has particular application in the alteration of the structure of water, to provide advantageous and beneficial properties as described below.

The plasma generation means may comprise at least one electrode defining an anode, and at least one cathode element spaced from the at least one electrode. The at least one electrode is located such that when liquid flows through the flow channel the at least one electrode is spaced above the surface of the liquid in the gaseous phase and the at least one cathode is located within the flow channel and arranged such that when liquid flows through the flow channel it is at least partially submerged beneath the surface of the liquid, such that the plasma field is generated in the gas phase and extends to and contacts the surface of the liquid.

As the cathode of the plasma generation means is located at least partially beneath the liquid, and the anode defined by the electrode is spaced from the liquid on the gaseous phase, plasma discharge is formed between the electrode (anode) in the gas phase and surface of the treated liquid, with the plasma formed in the gas between the electrode and the cathode extending to and contacting the surface of the liquid passing through the flow channel. The interaction of the plasma with the liquid causes impurities, such as heavy metals or particulate matter dissolved in the water to convert to solid insoluble particulates, which may subsequently be removed from the water by know filtration methods.

Where reference is made herein to the location of the anode ‘above’ the flow channel, the term ‘above’ should be interpreted as meaning above relative to the liquid surface i.e. the anode is outside of the liquid, rather than vertically above. While in the preferred embodiment the anode is located vertically above the liquid surface, in an alternative embodiment in which the flow channel is vertically oriented, the anode may be horizontally spaced from the flow channel while still being ‘above’ the surface of the liquid.

Plasma discharge in rarefied conditions of reduced pressure is most stable at low current and relatively high voltage. Therefore, the system is able to operate under optimised conditions with a low current demand. It is desirable to maintain current at low levels as an increase in electric current over 200 mA results in the occurrence of contracted discharge, i.e. classic arc discharge, whereupon the temperature rises sharply, and the liquid starts boiling. This is avoided through the use of a plasma reaction.

The apparatus preferably includes an anode in the gas phase, and cathode in the liquid phase. In an alternative embodiment the cathode may be in the gas phase, and anode in the liquid phase. In a yet further alternative embodiment both electrodes may be in the gas phase in close proximity to the liquid surface. The embodiment in which the anode in the gas phase, and the cathode in the liquid phase is most preferable, since it results in the base of the plasma discharge cone lying on the liquid surface.

The base of the reaction chamber forming the anode is preferably formed from stainless steel, or a similar material having low corrosion properties in acidic or alkaline media.

The at least one electrode is preferably positioned vertically above the flow channel, and centrally located along the width of the flow channel. This arrangement advantageously enables the electrode to be maintained above the surface of the liquid in the gaseous phase.

Preferably a portion of the flow channel defines the cathode. The flow channel comprises a base, and preferably it is at least a portion of the base which defines the cathode. In this way, there is no requirement for a separate cathode. In addition, the entire body of water flowing through the flow channel passes over the cathode, and hence is exposed to the contact plasma generated between the cathode and the anode defined by the electrode.

A housing may be provided having a liquid inlet arranged to supply liquid to the flow channel and a liquid outlet arranged to receive liquid from the flow channel. The housing encloses the flow channel and enables the ambient conditions surrounding the liquid to be monitored and controlled.

Preferably at least a section of the housing defines a reaction chamber within which the at least one electrode and flow channel are housed. Defining a specific reaction chamber in which the plasma field is applied to the flow channel permits further control over the reaction conditions by defining a specific reaction environment.

The reaction chamber preferably comprises a base and a pair of siding members arranged longitudinally at laterally spaced locations across the width of the base of the reaction chamber, the siding members defining the sides of the flow channel, and the portion of the base between the siding members defining the base of the flow channel. The siding members enable the base of the housing itself to be used as the base of the flow channel be cooperating with the base to form the flow channel, thereby permitting a simplified and efficient configuration, which minimises parts and hence cost. In addition, utilising the base of the housing as the flow channel base permits effective cooling of the base, as described below.

The siding members are preferably formed from a dielectric material. The use of a dielectric material enables the siding members to electrically isolate and define the base of the flow channel as the cathode.

The housing may comprise an inlet chamber arranged to receive liquid from the liquid inlet and including a weir plate over which liquid from the inlet chamber flows into the flow channel. The liquid is passed into the inlet through an antifoamer, which prevents problems the formation of surface foam and prevents entrained or entrapped air.

The inlet preferably includes a flow regulator for regulating the inlet flow rate of the liquid to be treated. The system may further include a liquid sensor for sensing the depth of liquid within the flow channel. A controller may be provided to control the flow regulator based on a signal from the liquid sensor to selectively vary the depth of the liquid in the flow channel.

The apparatus may further comprise tilting means for varying the inclination of the flow channel along its length. Varying the inclination of the flow channel enables the depth of the liquid within the flow channel to be selectively varied.

The titling means may comprise pivot means and an actuator spaced longitudinally from the pivot means relative to the length of the flow channel, the actuator being configured to cause the flow channel to pivot about the pivot means to vary the inclination thereof. The flow channel is inclined downwards towards the outlet, and the tilting means enables the gradient of this downward slope to be varied. The actuator may be an automated actuator such as a hydraulic or pneumatic piston, and may be controlled by the controller in response to the depth sensor, in cooperation with or independently of the inlet flow regulator.

The flow channel may be contained within a housing and the pivot means and actuator may be connected to the housing at longitudinally spaced locations relative to the length of the flow channel. Preferably, the pivot means is connected to a first end of the housing proximate the liquid outlet and the actuator is connected to the longitudinally opposing end.

Cooling means may be provided for removing heat from the at least a portion of the base of the flow channel defining the plasma cathode. This enables isothermal conditions of the liquid within the flow channel to be maintained, and advantageously ensures that the temperature of the liquid does not exceed boiling point.

The cooling means may comprise a fluid channel configured to pass a flow of coolant fluid into thermally absorbent contact with the lower surface of the base of the flow channel. The fluid channel may be defined by a chamber disposed beneath the base of the housing, the chamber including a fluid inlet and a fluid outlet arranged such that the coolant fluid flows in a substantially opposing direction to the flow of liquid through the flow channel.

A plurality of electrodes may be supported by the housing and the plurality of electrodes may be selectively deactivated to vary the plasma generated. The plasma generation means may be configured to generate a non-equilibrium contact plasma.

In another aspect of the invention there is provided a method of liquid treatment as described in the accompanying claims. The method comprises passing a flow of liquid to be treated through a flow channel; and generating a plasma field in the gas phase above the surface of the liquid in the flow channel such that the plasma contacts the surface of the liquid.

The method of generating a plasma field may comprise providing an electrode defining an anode in the gas phase above the liquid channel and providing a cathode element in the flow channel beneath the surface of the liquid, and applying a current to the electrode to generate a potential difference between the anode and the cathode.

The present invention will now be described by way of example only with reference to the following illustrative figures in which:

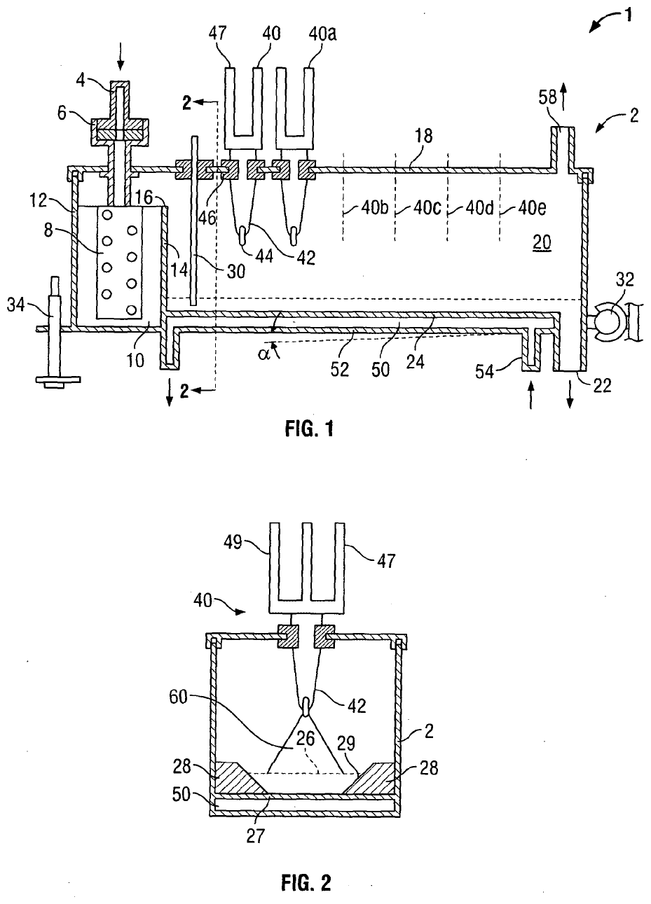

FIG. 1 shows a longitudinal section view of a liquid treatment apparatus according to an embodiment of the invention; and

FIG. 2 shows a transverse cross sectional view of the arrangement of FIG. 1.

Referring to FIG. 1, a water treatment apparatus 1 comprising a housing 2 through which water is passed for treatment. Treatment of the water may be for the removal of contaminants for example from industrial processes, naturally occurring pollutants, and/or for the activation of the water for various applications which are discussed in further detail below.

The housing 2 includes a water inlet 4 at one end. The water inlet 4 is configured for connection to a water source, and comprises a flow regulator 6 for controlling the inlet flow rate. The inlet 4 is connected to an antifoamer 8, which comprises a perforated cylindrical container contained within a holding tank 10. The water from the inlet 4 passes into the antifoamer 8, and the through the perforations into the holding tank 10. The anti-foamer thereby prevents problems the formation of surface foam and prevents entrained or entrapped air.

The holding tank 10 is defined by the end wall of the housing 12 and a baffle 14. The height of the baffle 14 defines the depth and hence the holding volume of the holding tank 10. The upper edge 16 of the baffle 14 is spaced from the roof 18 of the housing 2, such that the baffle 14 defines a weir. Water overflowing the weir defined by the baffle 14 flows into the reaction chamber 20 of the housing 2.

The reaction chamber 20 includes a water inlet defined by the baffle 14, and a water outlet 22 at the opposing end of the chamber 20. The base 24 of the reaction chamber 20 adjoins the baffle 14 at one end, and extends to the outlet 22 at its opposing end. The base 24 defines the base of a flow channel 26, which extends from the inlet 14 of the reaction chamber to the outlet 22.

As shown in FIG. 2, a pair of channel siding members 28 extends longitudinally along the base 24 of the reaction chamber 20. The siding members 28 are spaced apart across the width of the base 24 and define the width of the flow channel 26 in combination with the portion of the base exposed between siding members 28, with the siding members 28 forming the sides of the channel 26. The portion the base 24 exposed between the siding members 28 defines the base 27 of the flow channel 26. The inner edges of the siding members 28 define the side walls of the channel 26 and are sloped outwardly to provide an efficient flow profile. The spacing of the inner edges 29 of the siding members 26 across the width of the housing 2 determines the width of the flow channel 26.

The inlet 4 is located in and enters the housing 2 through the upper surface 18. The outlet 22 extends downwardly from the base 24 at the opposing end of the housing 2. Water may he pumped through the inlet 4 into the housing 2, or moved under the action of a pressure head, or by any other suitable means. The water then passes over the baffle 14 into the flow channel 26 of the reaction chamber 20. The water flows through the channel 26, contained by the siding members 28, to the outlet 22 under the action of gravity. To facilitate this action, the base 24 of the reaction chamber 20 is angled such that it slopes downwardly from the end proximate the baffle 14 towards the outlet 22.

The flow rate of water through the reaction chamber 20 is determined by the flow rate of water into the housing 2 via the inlet 4. The inlet flow rate is controlled by a variable flow regulator 6, which permits continuous but regulated flow into the holding tank 10. A liquid sensor 30 measures the depth of the water in the flow channel. For a given flow rate, the depth of the water in the flow channel 26 is determined by the gradient of the slope of the base 24. To control the depth of the water in the flow channel 26, the inclination angle of the base 24 is variable by controlling the inclination of the housing 2.

The housing 2 is supported at the outlet end by a pivot joint 32, which may be a ball joint or any suitable joint providing vertical pivoting about a horizontal axis. The opposite end of the housing 2 is mounted and supported on a vertical actuator 34. The actuator 34 may be a driven linear actuator such as a hydraulic or pneumatic piston, or may be a manual actuator such as a lockable slide pin. The actuator 34 is configured to lift the end of the housing 2 to which it is connected, causing the housing to pivot about the pivot joint 32. The actuator 34 therefore enables the inclination angle of the flow channel 26, and hence the flow depth therein, to be selectively varied through the raising and lowering of the end to which it connected.

The system includes a controller (not shown) which is configured to determine the water depth in the flow channel 26 in response to an input signal from the depth sensor 30, and to control the flow regulator 6 and/or the actuator 34 accordingly to ensure a predetermined depth of water and flow rate through the flow channel 26. For a given flow rate, variation of the actuator 34 height effects a variation in flow depth, while the flow regulator is used to vary the flow rate, and can vary the flow depth for a given inclination.

An electrode 40 is mounted to and supported by the roof 18 of the housing 2. The electrode 40 is conical in shape and has an electrically conductive tip 44 formed from thoriated tungsten. The tip 44 is held within a conical support of the electrode 40. The conical body 42 of the electrode 40 is mounted to the roof 18 by a sealing and insulating member 46, and such that the tip 44 is galvanically disconnected and electrically isolated from the housing 2. The electrode 20 is positioned across the width of the housing such that the tip 44 is transversely located centrally over the flow channel 26 and along the length of the housing such that it is located over a predetermined longitudinal location over the channel 26.

The apex of the tip 44 of the electrode 40 is directed downwardly towards the channel 26. The height of the roof 18 and the length of the electrode 40 is selected such that the tip 44 of the electrode 20 is sufficiently spaced from the base 27 of the flow channel such that when the flow channel 26 contains a flow of water, the tip 44 is spaced from the surface of the water and held in the gas phase within the reaction chamber 20.

The electrode further comprises a radiator section 47. The radiator 47 is formed of a material having a high thermal conductivity, and includes a plurality of upwardly extending fins which act as a heat sink to effect and optimise heat loss from the electrode 40.

The electrode 40 is connected to an electrical power supply, and defines an electrical anode. The base 24 of the reaction chamber 20 is formed from an electrically conductive material, and defines an electrical cathode corresponding to the anode of the electrode 40. The effective width of the base 27 of the flow channel 26 is defined by the siding members 28. The siding members 28 are formed from a dielectric material, such that they electrically partition the base 27 of the flow channel 26.

A cooling channel 50 is provided beneath the base 24 of the reaction chamber 20. A further plate 52 is provided beneath and spaced from the base 24 to define the cooling channel 50. The cooling channel 50 includes a cooling fluid inlet 54 and a cooling fluid outlet 56. The inlet 54 is located proximate the outlet 22 of the reaction chamber, and the outlet 56 is located proximate the baffle 14 at the opposing end of the base 24. Cooling fluid is pumped through the cooling channel in an opposing direction to the flow of water through the flow channel 26 to create a contra-flow which optimises cooling of the base 24.

A vacuum is applied to the reaction chamber 20 via outlet 58. The presence of a vacuum in the reaction chamber 20 assists in the formation of a stable plasma discharge, and provides for subsequent reliable and stable operation of plasma reactor. The value of rarefaction of the gas within the reaction chamber 20 is maintained below the threshold of natural boiling of the liquid in the reactor at established temperature conditions. In addition, the vacuum is operated to maintain rarefaction above a minimum limit required for plasma stability.

In use, water to be treated is passed into the housing 2 through the inlet 4 and caused to flow through the flow channel 26 by the inclination of the housing 2 by the actuator 34. When a flow of water is created through the flow channel, the base 27 of the channel is submerged entirely beneath the surface of the water, and the tip 44 of the electrode 40 is positioned above the surface of the water in the gas phase. Application of a predetermined voltage and current to the electrode 40 creates a potential difference between the anode defined by the electrode 40 and the cathode defined by the base 27 of the flow channel 26. The voltage and current supplied to the electrode 40 is controllable such that the potential difference between the anode 40 and cathode 27 leads to the generation of a non-equilibrium plasma in the gas phase between the anode 40 and cathode 27 defined by the tip 44 of the electrode 40 and the base 27 of the flow channel. The height of the electrode is set such that the apex of the tip 44 is spaced between 5 to 30 mm from the surface of the water.

The non-equilibrium plasma field 60 is generated by an initiation power supply unit (not shown), which is connected to both the electrode 40 and the base 27. The initiation unit provides a high voltage, low current power supply to the electrode 40. The ignition voltage is in the range of 12000-15000V, for an impulse duration on 1-1.5 ms. The application of the high voltage initiation pulse causes a plasma generating anode current to flow between the electrode (anode) 40 and the base (cathode) 27.

Following ignition, the supply parameters are switched to maintain the plasma flow. It has been found by the applicant that the optimum power supply parameters are an alternating, single phase input voltage of 50 Hz, 220V, 60 Hz 110V, and a constant pulsing output voltage regulated in the range of 700-1500V, with a maximum load current value of 0.25 A.

The non-equilibrium plasma current is regulated to maintain the temperature within the reaction chamber coolant below the boiling point of the liquid being treated within flow channel, to prevent rapid evaporation of the liquid. In addition to regulation of the plasma by through control of the power supply unit, temperature in the reaction chamber is further moderated by passing coolant liquid through the cooling channel 50 to remove heat from the base 27 of the flow channel 26. The flow through the cooling channel 50 is regulated to maintain isothermal conditions in the liquid undergoing treatment within the flow channel. Heat is additionally removed from the system through the radiator section 47 of the electrodes 40.

The plasma generated in the gas phase by the electrode 40 contacts the surface of the liquid in the region beneath the electrode 40 between the electrode 40 and the base 27. The surface contact plasma discharge acts to chemically active atoms and molecules within the liquid causing a set of chemical reactions of redox character, which act to remove pollutant material from solution within the liquid. The insoluble solid material can then be removed from the liquid with the use of known filtration methods. As an example, data concerning extraction of manganese compounds from a solution under plasma action is presented.

A moderately concentrated solution with initial manganese content of (1.7-3.5)10⁻⁴ mol/l was passed through the water treatment apparatus 1, and subjected to the application of a non-equilibrium plasma. Action of the plasma resulted in discoloration of the liquid as a result of oxidation of the manganese causing the manganese to form a dark-brown sediment in the liquid in the form of MnO₂.2H₂O. In this case, manganese oxidation occurs as below:

Mn(VII)→Mn(IV)↓→Mn(II)

It has been found that the application of non-equilibrium contact plasma within the reaction chamber 20 results in a level of manganese extraction from such solutions in the order of 95-98%.

In a further example, dissolved Fe²⁺ in waste water may be oxidised into Fe³⁺ through the application of a contact non-equilibrium plasma, which results on the following reactions:

Fe²⁺+OH′→Fe³⁺+OH⁻ (1)

Fe²⁺+HO₂′→Fe³⁺+HO₂⁻ (2)

HO₂⁻+H⁺→H₂O₂ (3)

2Fe²⁺+H₂O₂→2Fe³⁺↓+2OH⁻ (4)

2Fe²⁺+H₂O₂+2H⁺→2Fe³⁺↓+2H₂O (5)

Once removed from solution, the insoluble sediment of iron hydroxide formed by this process is easily isolated by means of known methods of segregating liquid inhomogeneous systems. Processing of the liquid to remove the precipitated insoluble product created by the plasma treatment may be conducted once the liquid has exited the reaction chamber 20. The water treatment apparatus 1 may include processing/filtration apparatus to effect the removal of solid components from the liquid as an integral part of the system. Alternatively, the apparatus 1 may include connection means for onward connection to such processing apparatus.

The plasma acts most efficiently on aqueous solutions containing ions of polyvalent metals capable of changing their valence under the initiating influence of plasma field. The plasma initiates a change in the valence of heavy metals present in the aqueous solution causing them to form solid insoluble particles, which can then be removed from the aqueous solution with the use of known filtration methods. As such, waste waters containing for example cyanide compounds, which are a problematic by-product of industrial hydrometallurgical processes, as well as processes used for machine building which use electrodeposited coatings based on cyanide solutions.

The process of cyanide extraction occurs as follows. During the interaction of Zn(CN)₄²⁻ complex with H⁺ and OH⁻ particles, there is a tendency for the first coordination sphere of Zn atom to be destroyed, with subsequent formation of a Zn(OH)₂ complex and four molecules of HCN. Further HCN degradation in water solution under plasma action then occurs in accordance with the pattern below:

CN⁻+2OH⁻→CNO⁻+H₂O+2e, (1)

2CNO⁻+4OH⁻→2CO₂+N₂+2H₂O+6e, (2)

or

CNO⁻+2H₂O→NH₄⁺+CO₃²⁻ (3)

thus ensuring complete decomposition of toxic cyanide.

In the same manner, solutions containing cyanides of copper, silver, gold, cadmium and zinc can be decontaminated with the formation of solid insoluble metal oxides, or through the reduction of silver and gold to molecular form.

The flow channel 26 enables treatment of the waste water under continuous flow conditions. Once the contact plasma field 60 is initiated, it can be maintained and applied to the water passing as a continuous flow through the reaction zone defined beneath the electrode. This enables highly efficient process treatment of the water, as compared to example to single batch treatment of water under non-flow conditions within a treatment tank.

In addition to the removal of impurities from waste water, the contact plasma of the waste water treatment apparatus I of the present invention has been found to alter the structure of the water itself. The current understanding of water structure is based on a cluster structure, which has been confirmed by well-known spectral and physical-chemical methods. Water molecules have been shown to exist in complex cluster structures, rather than simple individual H₂O molecules. The degree to which the water molecules are clustered affects the action and absorption properties of the water. The applicant has found that the action of the non-equilibrium contact plasma on water within the flow channel 26 of the reaction chamber 20 breaks down the complex water cluster structure, to create a modified water structure consisting of smaller, simplified water molecules. This modified water structure enables the water to be absorbed, for example by the cell structures of plants, and a more rapid and efficient manner, thereby increasing the waters hydration properties. The modified water structure also improves cell take up of the water in other applications such as burn treatment and other medical applications where cell absorption of water facilitates healing.

Due to the presence of a dipole moment in the molecules of water, the application of high enough voltage results in partial reorientation of the water molecules. This breaks down bonds in the water molecules and results in the formation of ions of H⁺ and OH⁻, with further dissociation resulting in the formation of free radical OH and hydrated electron e_{(aq)}:

OH⁻→OH⁻+e_{(aq)} (1)

The resulting water is found to be electrochemically ‘activated’, containing volumetric clusters formed owing to the presence of hydrated electrons. The initial phase of water processing by the contact, non-equilibrium plasma also leads to the formation of ions, excited molecules of water and resulting electrons.

H₂O+e⁻→H₂O⁺+2e⁻ (2)

H₂O+e⁻→H₂O+e⁻ (3)

The next phase of processing is:

H₂O+H₂O⁺→H₃O⁺+OH (4)

e⁻+H₂O→e_{(aq)}+H₂O (5)

H₂O⁻+H₂O⁻→H₂O₂+2H⁻ (6)

H₂O⁻→OH⁻+H⁻ (7)

Thus, several ion pairs formed, and are grouped around six excited water molecules, which themselves can create up to nine pairs of radicals. Owing to their big concentration, reactions of radical recombination take place, with formation of products of activation:

OH⁻+H⁻→H₂O (8)

OH⁻+OH⁻→H₂O₂ (9)

H⁻+H⁻→H₂ (10)

e_{(aq)}+e_{(aq)}+2H₂O→H₂+2OH⁻ (11)

Due to the homogenous distribution of active particles, radical-molecular reactions become an important, key process.

H₂+OH⁻→H₂O+H⁻ (12)

H₂O₂+H⁻→H₂O+OH⁻ (13)

H₂O₂+e(aq)→OH⁻+OH⁺ (14)

H₂O₂+H₂O⁻→H₂O+OH⁻ (15)

These reactions lead to the chain mechanism of water breakdown and formation of peroxide and super-peroxide compounds.

Apart from the above mentioned particles, hydro-peroxide radicals HO₂⁻ are also formed in water in small amounts, when water is treated by contact non-equilibrium plasma method.

H₂O₂+OH⁻→H₂O+HO₂⁻ (16)

Most intensely, this radical is formed in water that contains dissolved oxygen:

H⁻+O₂→HO₂⁻ (17)

H⁺+e_{(aq)}+O₂→HO₂⁻ (18)

In turn, hydro-peroxide radical facilitates the formation of oxygen through the following reactions:

H₂O₂+H⁻→H₂O+OH⁻ (19)

H₂O₂+e_{(aq)}→OH⁻+OH⁺ (20)

H₂O₂+H₂O⁻→H₂O+OH⁻ (21)

During the process of treatment of water with contact, non-equilibrium plasma, super-peroxide compounds are also formed, contributing to structural transformation of water and accumulation in it of hydrogen peroxide.

HO₂⁻+HO⁻→H₂O₃ (22)

HO₂⁻+HO₂⁻→H₂O₄ (23)

Taking into consideration all of the above mentioned processes, it is obvious that treatment of water with contact, non-equilibrium plasma results in fundamental changes in the structure of the water.

Each of the ions of H₃O⁺ is surrounded by five negatively charged molecules of water, and forms meta-stable non-charged cluster compound H₃O⁺_{aq}(H₂O^{0,2e})₅, through the following mechanism of formation:

6H₂O→2(OH⁻.H₂O)+2H₃O⁺ (24)

2(OH−.H₂O)→2(e_{(aq)}.H₂O)+2OH⁻ (25)

OH⁻+OH⁻→H₂O₂ (26)

2(e_{(aq)}.H₂O)+2H₃O⁺→2H⁻+4H₂O (27)

In this arrangement, reactions of OH-radicals take place, which are paramagnetic and interact with magnetic and electric fields. As a result, the increase of OH-radicals and H₂O₂ accumulation takes place.

The accrued data on the length of existence of meta-stable cluster compounds give evidence that, for example oligomer 5H₂O.e_{(aq)}, becomes negatively charged before it's breakup, as a result of below reaction:

H₂O+e_{(aq)}→OH⁻+H⁻ (28)

This participates in the formation of a large number of meta-stable compounds. Thus, the broken up fragments of metastable cluster formations replicate themselves, and in doing so, facilitate the process of electron exchange. Precisely because of this continuously repeatable process of formation and breaking up, the cluster structure of the resultant water possesses stability, and new, previously non-existing physical and chemical characteristics.

Research into characteristics of water, activated by this invented method, has revealed its high oxidation-reduction potential and the unique parameters and characterisitics, including:

hydrogen peroxide and super-peroxide compounds levels between 50-1,500 mg/l,

dynamic viscosity of 1.055-1.075 MPa,

electric conductance 5.2·10⁻¹⁰-5.8·10⁻⁸ cm/m,

agility of positive charged particles (31.5-32.0)·10⁻⁸ M² B⁻¹c⁻¹,

agility of negative charged particles (6.5-7.0)·10⁻⁸ M² B⁻¹c⁻¹,

pH between 2.5-11.0.

Use of physical and chemical methods of analysis has provided experimental confirmation of the changes in the cluster structure of the activated water. Using spectral methods to examine activated water, changes of a spectrum in the area of 700 sm⁻¹, responsible for fluctuations related to the displacement of hydrogen atom, participating in intermolecular hydrogen relationship, are evident. After the glow discharge plasma treatment of water, the maximum range of absorption in this part of IR-spectrum has low-frequency displacement from 714 cm⁻¹ up to 680 sm⁻¹, which points to the change in intermolecular association structure (cluster structures) in the activated water. At the same time, after 2 weeks in storage, the bulk of a range of absorption remains in the same place, i.e. the structure of water within 2 weeks does not revert to an initial formation (thus, cluster structure of plasma activated water is preserved).

A method of combined (Ramanov) light dispersion (CLD) shows differences in spectrums of secondary emission of the initial and activated water. In the initial water, in the area of 810-950 sm⁻¹, a number of lines with a maximum of 827 sm⁻¹ and width about 15 sm⁻¹ is observed The weakest of observed lines has its maximum near 877 sm⁻¹ and located in the field of O₂²⁻ oscillations, a commonplace for the solution of hydrogen peroxide. In the activated water, line in the area of O₂²⁻ oscillations becomes prevailing due to fading of three others.

Measurement of NMR-spectrums of the initial and activated water demonstrated their important distinctions:

| | Value of chemical shift | Value of width of a line |
|---|---|---|
| Initial water | 4.3798 m.d. | 6.354 ± 0.002 Hz |
| Activated water | 4.3829 m.d. | 7.107 ± 0.002 Hz |

Difference of chemical shifts is shown to be about 0.003 m.d., or, in recalculation for frequencies, about 1 Hz for a used nuclear magnetic resonance ¹H working frequency of 300 MHz. Thus, spectrums of a nuclear magnetic resonance ¹H demonstrate distinctions in chemical shifts and widths of the initial and activated water.

Measurement of the parameters of the initial and activated water by a method of proton magnetic relaxation (PMR) and processing of the results of the experiments, averaged by whole range of measurements of the spin-lattice relaxation time T₁, testify that the agility of hydroxonium ion H₃O⁺ is higher in the activated water, as well as for ions, containing hydroxonium as a component (i.e. as the self-standing molecular group), that corresponds with theoretical results of gas-plasma discharge modelling.

| | | Maximum deviation from |
|---|---|---|
| | Average value T₁ [sec] | an average |
| Initial water | 2.73 | ±0.05 |
| 3% H₂O₂ solution | 2.51 | ±0.03 |
| Activated water | 2.34 | ±0.07 |

Thus, PMR-measurements demonstrate distinctions of spin-lattice relaxation of plasma activated water, and characterize the increased agility of hydroxonium ions that are the result of plasma activation.

The theoretical and experimental research proves the presence of peroxide compounds in water, activated with low temperature, non-equilibrium, contact plasma, and corroborates the existence of new, activated water with stable cluster structure.

Variations in the plasma treatment process may be effected by varying the number of electrodes within the reaction chamber. The roof of the housing 18 is configured to receive a series of electrodes along its length. The arrangement shown in FIG. 1 includes a first electrode 40 and a second electrode 40a spaced longitudinally from the first electrode 40 and mounted to the roof 18 in a similar manner. Locations 40b-40e define further sites for receiving additional electrodes. Each electrode 40 in the series creates a plasma discharge zone which contacts a predetermined surface area of the liquid flowing beneath it. Increasing the number of electrodes 40 increases the surface reactions zones, and hence the action of the plasma on the liquid as it passes along the flow channel 26. For a given volume of liquid, the action of the plasma on the liquid is dependant in part on the time the liquid is within the plasma reaction zone, which defines the reaction period.

The reaction period is dependant on the flow rate and the number of electrodes 40 present in the reaction chamber 20. For a given number of electrodes 40, the reaction period may be varied by varying the flow rate through control of the inclination of the housing 2, with an increased flow rate resulting in a decreased reaction period. For a given flow rate, the reaction period is variable by varying the number of electrodes 40, and hence the number of reaction zones within the reaction chamber 20. Therefore, for example, in applications where it is required to treat large volumes of liquid in a short period time, the housing may be modified to include a larger number of electrodes 40, and inclined to increase flow rate, such that the largest volume of water is treated in the most effective manner.

The reaction chamber 20 may be configured to include a plurality of flow channels 26, arranged parallel to each other along the length of the housing. In this arrangement, the housing 2 further includes multiple rows of electrodes corresponding to and arranged above each of the flow channels. Increasing the number of flow channels 26 and corresponding electrodes increases maximum flow rate through the housing and hence the volume of liquid which may be treated in a given period.

The effect of the non-equilibrium contact plasma on the liquid within flow channel is also dependant on the liquid depth. During treatment by the plasma field the liquid continuously moves along the reaction channel 26, both longitudinal and transverse mixing occurs, which is typical for turbulent or transient conditions of the liquid flow. It means that surface layer of liquid subjected to plasma treatment is renewed continuously, as a result of mixing, which causes activation of all volume of the liquid moved and treated. The efficiency of the plasma treatment is dependant on the depth of penetration of the plasma active components on to the liquid. Average depth of penetration of plasma active components into surface layer of water varies in the following limits: atoms, radicals, excited molecules—over 0.1 mcm; ions, electrons—up to 10 monolayers; quanta of ultraviolet radiation—up to 10 mcm. As such, liquid depth is adjusted to ensure that the penetration depth is optimised for a given plasma field strength

It will be appreciated that in further embodiments various modifications to the specific arrangements described above and shown in the drawings may be made. For example, while the invention is described for the treatment and purification of water, other liquids may also be treated in the same manner using the device, and its application is not limited to use with water.

1. A liquid treatment apparatus comprising:
a liquid flow channel configured to receive and channel liquid;
tilting means for varying the inclination of the liquid flow channel along its length;
plasma generation means comprising at least one electrode defining an anode, and at least one cathode element spaced from the at least one electrode;
wherein the at least one electrode is located relative to the liquid flow channel such that when liquid flows through the liquid flow channel the at least one electrode is spaced above the surface of the liquid in a gas phase and the at least one cathode is located within the liquid flow channel and arranged such that when liquid flows through the liquid flow channel it is at least partially submerged beneath the surface of the liquid, such that a plasma field is generated in the gas phase and extends to and contacts the surface of the liquid flowing therethrough.

2. (canceled)

3. A liquid treatment apparatus according to claim 1, wherein the at least one electrode is positioned vertically above the flow channel.

4. A liquid treatment apparatus according to claim 1, wherein a portion of the flow channel defines the cathode.

5. A liquid treatment apparatus according to claim 3, wherein the flow channel comprises a base element and at least a portion of the base element defines the cathode.

6. A liquid treatment apparatus according to claim 1, further including a housing having a liquid inlet arranged to supply liquid to the flow channel and a liquid outlet arranged to receive liquid from the flow channel, wherein at least a section of the housing defines a reaction chamber within which the at least one electrode and flow channel are housed.

7. (canceled)

8. A liquid treatment apparatus according to claim 6, wherein the reaction chamber comprises a base and a pair of siding members arranged longitudinally at laterally spaced locations across the width of the base, the siding members defining the sides of the flow channel, and the portion of the base between the siding members defining the base of the flow channel.

9. A liquid treatment apparatus according to claim 8, wherein the siding members are formed from a dielectric material.

10. A liquid treatment apparatus according to claim 8, comprising an inlet chamber arranged to receive liquid from the liquid inlet and including a weir plate over which liquid from the inlet chamber flows into the flow channel.

11. A liquid treatment apparatus according to claim 6, wherein the reaction chamber comprises an outlet configured for connection to a vacuum to create a rarefied atmosphere within the reaction chamber.

12. (canceled)

13. A liquid treatment apparatus according to claim 1, wherein the titling means comprises pivot means arranged at one end of the flow channel and an actuator spaced longitudinally from the pivot means relative to the length of the flow channel, the actuator being configured to cause the flow channel to pivot about the pivot means.

14. A liquid treatment apparatus according to claim 13, wherein the flow channel is contained within a housing and the pivot means and actuator are connected to the housing at longitudinally spaced locations relative to the length of the flow channel.

15. A liquid treatment apparatus according to claim 14, wherein the pivot means is connected to a first end of the housing proximate the liquid outlet and the actuator is connected to the longitudinally opposing end.

16. A liquid treatment apparatus according to claim 1, further comprising cooling means for removing heat from the at least a portion of the base of the flow channel defining the plasma cathode wherein the cooling means comprises a fluid channel configured to pass a flow of coolant fluid into thermally absorbent contact with the lower surface of the base of the flow channel.

17. (canceled)

18. A liquid treatment apparatus according to claim 16, wherein the fluid channel is defined by a chamber disposed beneath the base of the housing, the chamber including a fluid inlet and a fluid outlet arranged such that the coolant fluid flows in a substantially opposing direction to the flow of liquid through the flow channel.

19. A liquid treatment apparatus according to claim 1, configured to selectively include a plurality of electrodes defining a plurality of anodes arranged at spaced locations along the length of the flow channel.

20. A liquid treatment apparatus according to claim 1, wherein the plasma generation means is configured to generate a non-equilibrium contact plasma.

21. A method of liquid treatment comprising:
passing a flow of liquid to be treated through a flow channel;
generating a plasma field in the gas phase above the surface of the liquid in the flow channel; and
causing the plasma to contact the surface of the liquid to react therewith, wherein the method of generating a plasma field comprises providing an electrode defining an anode in the gas phase above the liquid channel and providing a cathode element in the flow channel beneath the surface of the liquid, and applying a current to the electrode to generate a potential difference between the anode and the cathode.

22. (canceled)

23. A method according to claim 21, further comprising the step of filtering the liquid after it has passed though the flow channel and been contacted by the plasma field.

24. A method according to claim 21, further comprising the step of selectively varying the inclination of the flow channel to vary the depth of the liquid.

25. A method according to claim 21, further comprising the step of selectively varying the number of electrodes to selectively vary the level of plasma contact with the liquid.

26-27. (canceled)
